(19) United States
(12) Patent Application Publication
(10) Pub. No.: US 2006/0217132 A1
(43) Pub. Date: Sep. 28, 2006

(54) High resolution localization for indoor environments

(75) Inventors: Justin Drummond-Murray, Chalfont St. Giles (GB); Andrew M. Terry, Riverton, UT (US); Niels van Erven, Santa Clara, CA (US); Peter Doggart, Chicago, IL (US)

Correspondence Address: HAYNES BEFFEL & WOLFELD LLP, P O BOX 366, HALF MOON BAY, CA, 94019, US

(73) Assignee: 3COM Corporation, Marlborough, MA (US)

(21) Appl. No.: 11/087,412

(22) Filed: Mar. 23, 2005

(51) Int. Cl. H04Q 7/20

(52) U.S. Cl. 455/456.2

(57) ABSTRACT

The present invention relates to locating a person who is operating a wireless communications device in an indoor environment. In particular, it relates to processing various combinations of RSSI, direction of arrival and flight time characteristics of a signal, as received at two or more and preferably three or more access points. In one embodiment, the access points implement a wireless LAN (WLAN) and the communications device is a telephone operating over the WLAN. In another embodiment, the localization of a wireless device allows a system to reject users who are outside a predefined physical area.

### RELATED APPLICATION

This application is related to U.S. patent application Ser. No. 10/843,218, “SDMA System Using MU-SIMO for the Uplink and MU-MISO for the Downlink”, by inventor Niels van Erven, filed on 11 May 2004. The related application is incorporated by reference.

### BACKGROUND OF THE INVENTION

The present invention relates to locating a person who is operating a wireless communications device in an indoor environment. In particular, it relates to processing various combinations of RSSI, direction of arrival and flight time characteristics of a signal, as received at two or more and preferably three or more access points. In one embodiment, the access points implement a wireless LAN (WLAN) and the communications device is a telephone operating over the WLAN. In another embodiment, the localization of a wireless device allows a system to reject users who are outside a predefined physical area.

Strong economic incentives exist for using voice over IP (VOIP) telephone service. It is expected that wireless and cellular telephone equipment manufacturers will add VOIP functionality to their handsets in the near future, allowing phone users within friendly premises to take advantage of VOIP infrastructure to avoid cellular tariffs.

Other devices, such as PDAs and laptops, also access WLANs. A variety of IEEE 802.11 standards have been promulgated to standardize both short range and metro area WLAN capabilities. As these standards are further implemented, users will increasingly tap into WLANs away from their own premises at locations such as airports, coffee shops, book stores, and hotels.

Out of concern for locating persons making emergency calls and general security considerations, agencies such as the FCC have mandated cellular telephone locator functionality, sometimes referred to as an E911 feature. This mandate has generally been met by incorporating global positioning system (GPS) receivers in handsets. However, GPS reception is poor inside of buildings.

An opportunity arises to devise a high resolution localization method and devices for indoor environments, where GPS is unlikely to work.

### SUMMARY OF THE INVENTION

The present invention relates to locating a person who is operating a wireless communications device in an indoor environment. In particular, it relates to processing various combinations of RSSI, direction of arrival and flight time characteristics of a signal, as received at two or more and preferably three or more access points. In one embodiment, the access points implement a wireless LAN (WLAN) and the communications device is a telephone operating over the WLAN. In another embodiment, the localization of a wireless device allows a system to reject users who are outside a predefined physical area. Particular aspects of the present invention are described in the claims, specification and drawings.

### BRIEF DESCRIPTION OF THE DRAWINGS

FIG. 1 illustrates an indoor environment with multipathing.

FIG. 2 illustrates an uncertainty zone resulting from inaccuracy of received signal strength (RSSI) measurements.

FIG. 3 illustrates localization to network access security.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

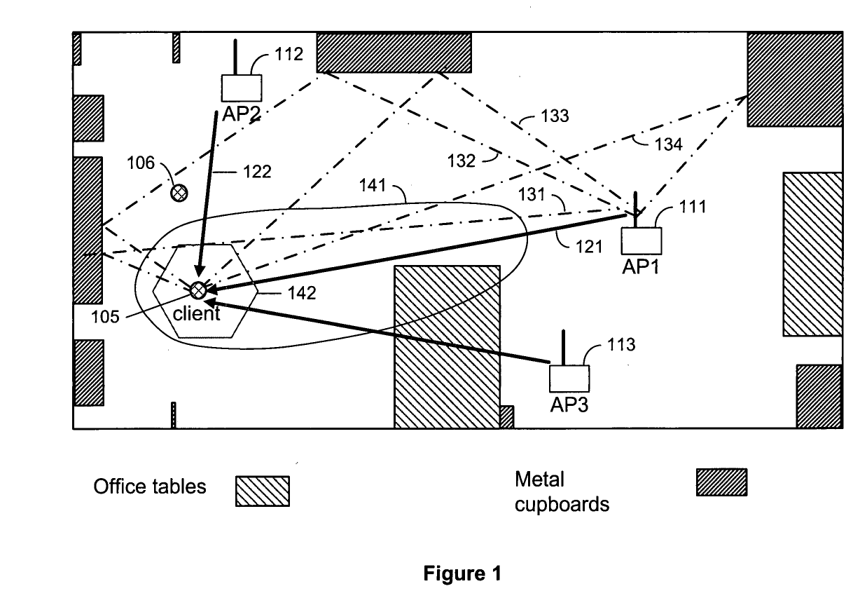

The indoor environment and complications of obscured line of sight and multipathing are illustrated in FIG. 1. In the figure, the wireless device is labeled “client” 105. This wireless device preferably is a WLAN device. Standards for connecting to a WLAN may include 802.11x compliant WLAN technology, line-of-sight microwave and RF access technology, unlicensed 2.4 or 5.25 GHz technology, Bluetooth technology, cellular technology, IS 95b compliant technology, enhanced GSM technology, GPRS technology, Metricom technology, and WMAN technology. It is not practical at this time to use satellite link technology, such as used in some new automobiles, because it suffers the same reception problems as GPS. The invention described herein could be applied to other RF transmitters in indoor environments. It might be applied to sensing RF emanations of receivers in indoor environments, as a security application—fans of espionage histories will recall the English success during WWII in locating covert radio installations by seeking out receiver emanations, even as transmitter circuits were quiet.

In FIG. 1, some features of an office that interfere with locating a wireless device are illustrated. Office tables and metal cupboards are positioned on this floor plan. Office tables, desks, chairs and the like may affect RF signal strength and reduce the effectiveness of relying on a received signal strength indicator to pin down a location. Walls, ceilings and floors in a mult-story building may have similar impacts. Metal cupboards and other RF reflective surfaces (even coated window panes) cause radio waves to follow multiple paths (131, 132, 133 and 134) from the transmitter to the receiver, known as multipathing. This causes well-known problems with decoding received signals. Applied to locating a wireless device, multipathing potentially impacts received signal strength, direction of arrival and time of flight. As a result, simple ranging triangulation or two point directional surveying is difficult to implement for an indoor environment.

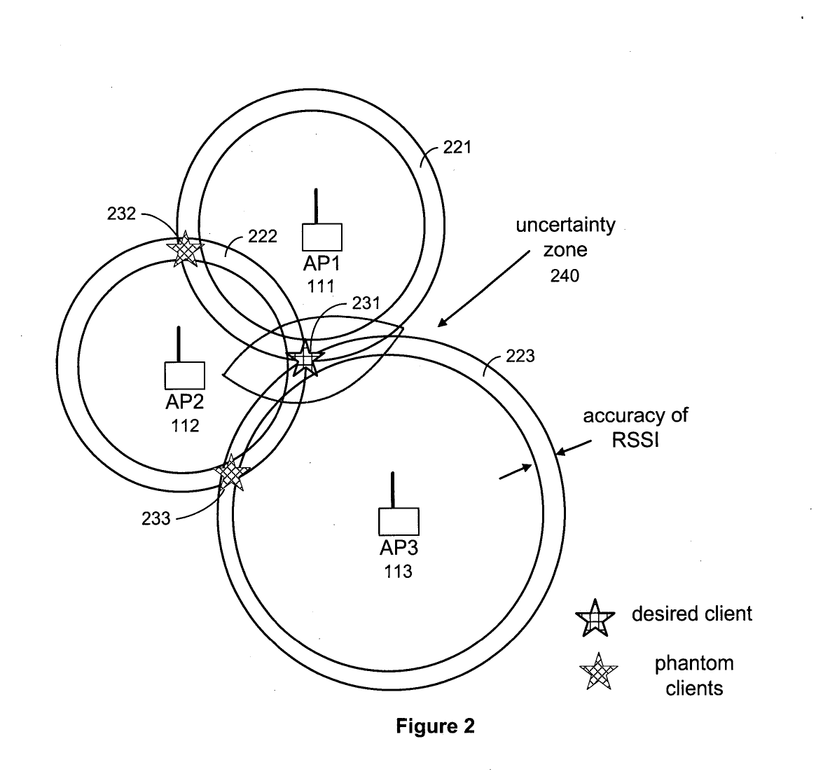

FIG. 2 further illustrates the problem of relying on simple ranging triangulation using received signal strength as a parameter. Those familiar with WLAN technology will recognize RSSI as a parameter used by wireless adapters. The RSSI parameter was not intended for use in locating wireless devices. Adapted to triangulation, RSSI information from a WLAN adapter has a range of error that can be illustrated by concentric circles. Three access points, 111, 112 and 113 are adapted to collect RSSI or other signal strength data. Circles 211, 221 and 231 around the access points indicate a margin of error, a limitation on the accuracy of RSSI as a range indicator. Uncertainty zone 240 illustrates how the overlapping error margins of the access points may yield an inexact or inaccurate device location.

Locating a wireless device using signal strength (range) data requires three access points. Using only two access points, 111 and 112, gives phantom client 232 as an equally likely position for the desired client 231. Similarly, using access points 112 and 113 generates phantom client 233. Finding the desired client 231 requires range data from all three access points to produce an unambiguous location fix in two dimensions or four access points for a location fix in three-dimensional space.

Returning to FIG. 1, a wide error range for location when using a single receiver and just direction of arrival data is illustrated by zone 141. Even worse, multipathing can produce a phantom client 106 by introducing a different direction of arrival from the wireless device. The phantom client may persist even with direction of arrival readings from two access points. Of course, the more direction of arrival readings, the clearer the line of sight (121 or 122 versus 123) and the less multipathing (131-33), the better the calculated location fix based on direction of arrival. Preferably, in a WLAN environment, an access point with an antenna array is used, capable of spatial separation among wireless clients, as described in the related application that has been incorporated by reference. Determining direction of arrival for a radio signal is old, so it is not necessary in this document to elaborate on determining the direction of arrival.

Combining received signal strength with direction of arrival improves location fixing and helps eliminate phantom clients. For instance, using two access points 111 and 112 to distinguish between client 105 and phantom client 106, the received signal strength at access point 112 should readily distinguish between 105 and 106, because the actual client is twice as distant as the phantom client.

A third parameter that can be used to determine a location is time of flight for energy traveling from the client to the access points. In one embodiment, time of flight measurement can be based on a round trip from the access point to the wireless device. The access point sends a packet, such as a data or pool packet. The wireless device, immediately upon receiving the packet, responds with an acknowledgement (ACK) packet. The time for receiving the ACK is measured by the access point. The one-way flight time becomes: t_flight=(measured time−TX/RX turnaround time−processing time)/2. Measurement accuracy may be improved by measuring and/or correcting crystal frequency differences between the wireless device and access point(s). Crystals presently in use may be accurate to 20 ppm. By applying over-the-air phase lock loop (PLL) techniques, the relative frequency of crystals may be improved to on the order of less than 0.05 ppm. Those of ordinary skill in the art will recognize this concept. This third parameter provides range information, like the RSSI data, but it is worth remembering that time of flight is proportional to distance traveled, while signal strength is proportional to the square of the distance that the signal is transmitted. Measurement of RSSI and flight time will be differently impacted by factors the impact the indoor environment.

The data parameters may be averaged out using a sliding window, instead of using single packet measurements, to improve accuracy. A particular access point will measure data parameters for wireless device clients that are not being serviced by the particular access point, as measurements are needed from more access points than the wireless device will be actively connected to. That is, a particular access point will keep track of wireless devices that it can see, even when they are subscribed to other access points or SSID clusters.

To collect data for evaluation by a location processing device, a data collection protocol is required. In one embodiment, a wireless switch may serve as the location processing device. The wireless switch would poll the wireless access points and obtain the relevant parameters. The wireless switch would be configured with the locations and orientations of the access points and their identifiers, so that the switch could build and refresh a complete localization picture upon receiving information from the access points. The orientations of the access points could be set or confirmed by using the direction of arrival between the access point and the wireless switch for reference. Alternatively, it could be set or confirmed using a reference wireless device, preferably positioned with a line of sight to one or more access points in question. Or, a compass, such as a flux gate, could be included in the access point.

Data collection could be performed on either a polled or asynchronous basis. Data could be collected from access points for single wireless devices or particular wireless devices, or for all or part of the data collected by the access point. The location processing device may be integral to an access point, so that data collection from the integrated access point is as simple as transferring data from one process to the other, running on the same processor, or sharing a memory location or data pipeline. The location processing device could be implemented using a general purpose processor, an FPGA gate array processor, a semi-custom or custom ASIC processor or other logic configuration.

Measuring two or three parameters from two or three access points will over-constrain locating a wireless device. In general, one needs as many equations as unknowns to solve a system. However, when some of the measurements may be inaccurate, techniques such as singular value decomposition (SVD) can be applied to use the extra information, the extra constraints, to solve the system. For further discussion of applying SVD, reference is made to the related application, which has been incorporated by reference.

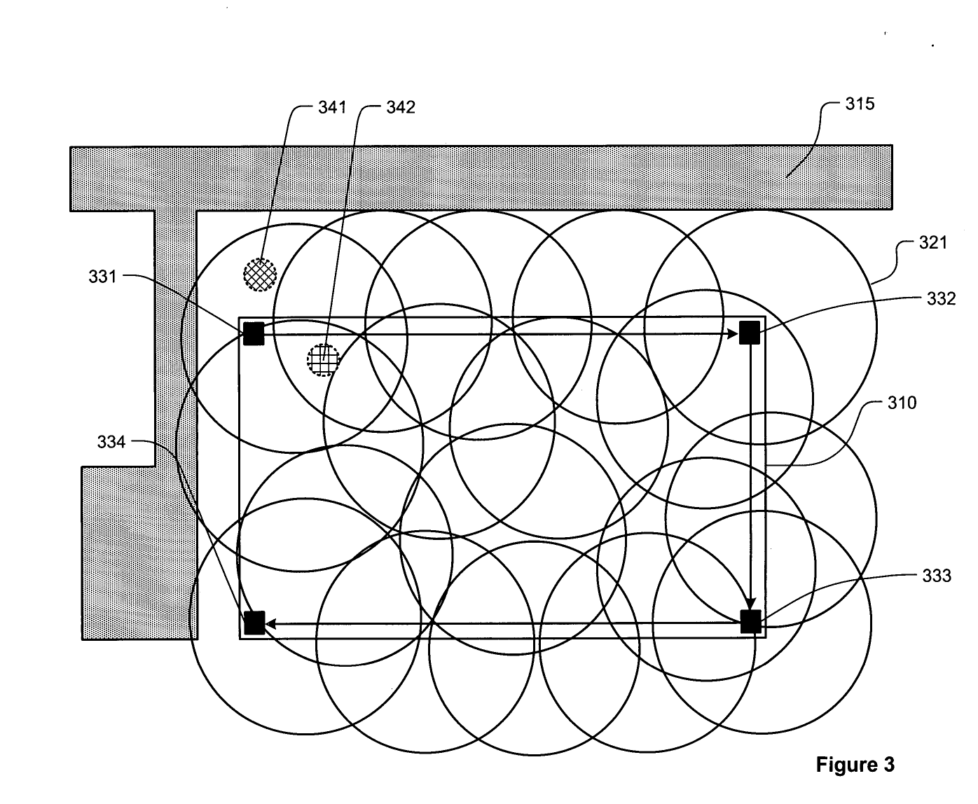

FIG. 3 applies localization to network access security. In the figure, a building 310 and outside features such as a road and parking lot 315 are illustrated. Within the building, a number of wireless access points project coverage, having radiation patterns such as 321. The radiation patterns of the wireless access points overlap, even when their effective usable radii do not. To map a predetermined area, mapping beacon or receiver, such as a laptop or other portable wireless device can be moved from one corner 331 of the area to the next 332, 333, 334. The location of the mapping beacon/probe or receiver can be used to generate a map of locations that are inside, versus outside the predetermined area. In this sense, the map may show which locations are inside one or more rooms, versus outside the rooms. As a mapping beacon, the wireless access points would measure signals from the mapping beacon and record them. Either corners of the predetermined area or points along the perimeter of the predetermined area could be measured. An advantage of using a beacon or probe is that the location of the receiving access points would not need to be precisely known, especially if the beacon were tracked at a plurality of points by each of the receiving access points or at least the receiving access points that overlapped with the perimeter of the predetermined area.

Alternatively, with a sufficient number of readings, a receiving device could map the locations of the access points and locations along the perimeter of the predetermined area. Both the access point locations and the perimeter could be defined using a receiving devices instead of a beacon.

Once the predetermined area has been mapped, a location processor can distinguish a wireless device 341 that is outside the predetermined area from one 342 that is inside the predetermined area.

### Some Particular Embodiments

The present invention may be practiced as a method or device adapted to practice the method. The same method can be viewed from the perspective of an overall system, an access point that measures parameters to locate a wireless device, or a location processing device that collects/receives data from the access points and calculates a location fix. The invention may be an article of manufacture such as media impressed with logic to carry out computer-assisted collection and forwarding of data or receipt of data and calculation of location fixes.

One embodiment is a method practiced by a system to locate a wireless device in an indoor environment. Preferably, the system uses three or more wireless access points connected by a wired or wireless network to a location processing device. In some embodiments, the system may use only two wireless access points. The wireless access points may be distinct from the location processing device or the location processing device may be integrated into one or more of the access points. The method includes collecting, at the wireless access points two or more data parameters about one or more signals received from the wireless device to be located, among parameters reflecting received signal strength, direction of arrival and flight time. This method further includes forwarding the collected data to the location processing device and calculating the location of the wireless device.

Other aspects of this method may include conformance of the wireless device and the access points to a standard for wireless network communications, such as an 802.11 standard. The wireless device may be a cellular phone with a WLAN communication channel, a PDA, a laptop computer or any device having a receiver that resonates with the frequency used by the access points. To report direction of arrival information, the wireless access points may need to be oriented in direction. Alternatively, this may be done by reference to an internal direction device, such as of fluxgate, by determining the direction of arrival of a reference signal, such as a beacon or a particular wireless device, or by evaluating a direction of arrival between the location processing device and the access point. The location processing device and access points may include logic to map their relative locations and allow a user to refine the mapping. The mapping may be overlaid on a building floor plan or site plan. When more data is available then needed to resolve a location, a mathematical technique such as singular value decomposition may be applied to take advantage of the extra information and to overcome inaccuracies in the data.

Another embodiment is a method practiced by a location processing device. This location processing device may operate in an indoor environment in conjunction with two, three or more wireless access points adapted to provide data to the location processing device. The method includes collecting from the wireless access points two or more data parameters about one or more signals received from the wireless device to be located, among parameters reflecting received signal strength, direction of arrival and flight time. This method further includes calculating the location the wireless device from two or more of the data parameters. Aspects of the previous method may be applied to this embodiment as well.

A further embodiment is a method practiced by an access point. This access point may operate in an indoor environment in conjunction with one, two or more additional wireless access points and the location processing device. The method includes collecting, at a particular wireless access point, received signal strength, direction of arrival and flight time data about one or more signals received from the wireless device to be located or, at least, collecting two of the three parameters. The method further includes forwarding the particular collected data to the location processing device, wherein the location processing device is adapted to calculate a location the wireless device from the forwarded data, used in combination with similar data from additional wireless access points. Aspects of the previous methods can be applied to this embodiment as well.

The methods above also may be embodied in devices. For instance, a system for locating a wireless device and indoor environment. This system may include three or more wireless access points having multiple antennas, coupled to a network. It further may include a location processing device in communication with the wireless access points. The wireless access points may be coupled to logic and resources adapted to calculate signal strength, direction of arrival and flight time of at least one signal from the wireless device or, at least, to calculate two of the three parameters. In this system, the location processing device further includes logic and resources to calculate a location of the wireless device from the received data. Aspects of the methods described above may be embodied in this system.

Another device embodiment is a location processing device, adapted to receive data from two, three or more wireless access points regarding one or more signals from a wireless device and to calculate the location of the wireless device. This location processing device includes a processor, working memory coupled to processor and program storage memory accessible to the processor. In this context, a processor broadly includes a general-purpose processor, an FPGA, a semi custom or custom ASIC processor, or equivalent logic resources. The location processing device further includes one or more ports accessible to the processor, adapted to receive data from the wireless access points and logic utilizing the processor, adapted to process the data received from the wireless access points and calculate the location of the wireless device. The data received includes at least two of data parameters for received signal strength, direction of arrival and flight time. Aspects of the methods described above may be embodied in this location processing device.

A further device embodiment is a multi-antenna access point, adapted to provide information about one or more signals from a wireless device to a location processing device. This access point includes an antenna an array and a signal processor, coupled the antenna array, which includes logic and resources to calculate received signal strength, direction of arrival and flight time characteristics (or at least two of the three) of the signals from the wireless device and to communicate the calculated characteristics to the location processing device. The access point further includes a port coupled to the signal processor, adapted to communicate the calculated characteristics to the location processing device. The port may provide wired or wireless access. Aspects of the methods described above may be embodied in this access point.

Described alternatively, one embodiment would be a method of locating a wireless device in an indoor environment using three or more wireless access points connected to a network. This method includes collecting, at the wireless access points, direction of arrival and at least one of receiving signal strength or flight time data about signals from the wireless device to be located and calculating at a location processing device a location of the wireless device using the data from the wireless access points. A further aspect of this embodiment is rejecting network access attempts by the wireless device when the location of the wireless device is outside a predetermined area.

Practicing this method embodiment, the collected data about the signals from the wireless access points may be forwarded via the network to a location processing device distinct from any of the wireless access points. Or, the location processing device can be incorporated in one of the wireless access points. The calculating may use at least the direction of arrival and the received signal strength data. Alternatively, it may use at least the direction of arrival and the time of flight data. Of course, it may use all three of the direction of arrival, received signal strength and time of flight data. The calculating can use the direction of arrival and received signal strength data for a first subset of the access points and the direction of arrival and the time of flight data for a second subset of the access points to calculate the location. These alternative methods of calculating the location may be combined with rejecting network access attempts by the wireless device when the location of the wireless device is outside a predetermined area. The predetermined area may be calculated by locating a beacon at various positions along the perimeter of the predetermined area or by locating a receiving device at various locations along the perimeter of the predetermined area.

A system embodiment for locating a wireless device in an indoor environment includes three or more wireless access points having multiple antennas, coupled to a network. Integrated into the wireless access points are first logic and resources adapted to calculate direction of arrival and at least one of received signal strength or flight time of signals from the wireless device. This system further includes a location processing device in communication with the first logic and resources, the location processing device including second logic and resources to calculate a location of the wireless device. This system may further include a network access control device in communication with the second logic and resources, the network access control device including third logic and resources to reject network access attempts by the wireless device when the location of the wireless device is outside the predetermined area.

The second logic and resources may calculate the location from the direction of arrival data and the received signal strength data. Alternatively, it may calculate the location from the direction of arrival at the time of flight data. Of course, it may use all three of the direction of arrival, received signal strength and time of flight data. The calculating can use the direction of arrival and received signal strength data for a first subset of the access points in the direction of arrival at the time of flight data for a second subset of the access points to calculate the location. These alternative configurations of the second logic and resources may be combined with a network access control device in communication with the second logic and resources, the network access control device including third logic and resources to reject network access attempts by the wireless device when the location of the wireless device is outside the predetermined area.

A component of the system embodiment may be a multi-antenna access point, adapted to provide information about one or more signals from a wireless device to a location processing device. This access point includes an antenna array, a signal processor, operatively coupled to the antenna array, including logic and resources to calculate received signal strength, direction of arrival and flight time characteristics of the signals from the wireless device. It further includes a port coupled to the signal processor, adapted to communicate the calculated characteristics to the location processing device.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for locating a wireless device such as a voice over IP phone, PDA or laptop computer, systems and components including logic and resources to locate a wireless device, media impressed with logic to carry out the methods, or data streams impressed with logic to carry out the method. It is contemplated that modifications and combinations will readily occur to those skilled in the art, which modifications and combinations will be within the spirit of the invention and the scope of the following claims.

We claim as follows:

1. A method of locating a wireless device in an indoor environment using three or more wireless access points connected to a network, the method including:
collecting, at the wireless access points, direction of arrival and at least one of received signal strength or flight time data about signals from the wireless device to be located; and
calculating at a location processing device, a location of the wireless device, using the data from the wireless access points.

2. The method of claim 1, further including rejecting network access attempts by the wireless device when the location of the wireless device is outside a predetermined area.

3. The method of claim 2, wherein the predetermined area is the inside of one or more rooms of a building.

4. The method of claim 1, further including forwarding the collected data about the signals from the wireless access points via the network to a location processing device distinct from any of the wireless access points.

5. The method of claim 4, further including rejecting network access attempts by the wireless device when the location of the wireless device is outside a predetermined area.

6. The method of claim 4, wherein forwarding the collected data uses a wired channel of the network.

7. The method of claim 4, wherein forwarding the collected data uses a wireless channel of the network.

8. The method of claim 1, wherein the calculating uses at least the direction of arrival and the received signal strength data.

9. The method of claim 8, further including rejecting network access attempts by the wireless device when the location of the wireless device is outside a predetermined area.

10. The method of claim 1, wherein the calculating uses at least the direction of arrival and the time of flight data.

11. The method of claim 10, further including rejecting network access attempts by the wireless device when the location of the wireless device is outside a predetermined area.

12. The method of claim 1, wherein the calculating uses the direction of arrival, the received signal strength data and the time of flight data.

13. The method of claim 12, further including rejecting network access attempts by the wireless device when the location of the wireless device is outside a predetermined area.

14. The method of claim 1, wherein the calculating uses the direction of arrival and the received signal strength data for a first subset of the access points and the direction of arrival and the time of flight data for a second subset of the access points.

15. The method of claim 14, further including rejecting network access attempts by the wireless device when the location of the wireless device is outside a predetermined area.

16. A system for locating a wireless device in an indoor environment, the system including:
three or more wireless access points having multiple antennas, coupled to a network;
first logic and resources, integrated into the wireless access points, adapted to calculate direction of arrival and at least one of received signal strength or flight time of signals from the wireless device; and
a location processing device in communication with the first logic and resources, including second logic and resources to calculate a location of the wireless device.

17. The system of claim 16, further including a network access control device in communication with the second logic and resources, including third logic and resources to reject network access attempts by the wireless device when the location of the wireless device is outside a predetermined area.

18. The system of claim 16, wherein the second logic and resources calculate the location from the direction of arrival data and the received signal strength data.

19. The system of claim 18, further including a network access control device in communication with the second logic and resources, including third logic and resources to reject network access attempts by the wireless device when the location of the wireless device is outside a predetermined area.

20. The system of claim 16, wherein the second logic and resources calculate the location from the direction of arrival data and the time of flight data.

21. The system of claim 20, further including a network access control device in communication with the second logic and resources, including third logic and resources to reject network access attempts by the wireless device when the location of the wireless device is outside a predetermined area.

22. The system of claim 16, wherein the second logic and resources calculate the location from the direction of arrival data, the received signal strength data and the time of flight data.

23. The system of claim 22, further including a network access control device in communication with the second logic and resources, including third logic and resources to reject network access attempts by the wireless device when the location of the wireless device is outside a predetermined area.

24. The system of claim 16, wherein the second logic and resources calculate the direction of arrival and the received signal strength data for a first subset of the access points and the direction of arrival and the time of flight data for a second subset of the access points.

25. The system of claim 24, further including a network access control device in communication with the second logic and resources, including third logic and resources to reject network access attempts by the wireless device when the location of the wireless device is outside a predetermined area.

26. A multi-antenna access point, adapted to provide information about one or more signals from a wireless device to a location processing device, the access point including:
an antenna array;
a signal processor, operatively coupled to the antenna array, including logic and resources to calculate received signal strength, direction of arrival and flight time characteristics of the signals from the wireless device; and
a port coupled to the signal processor, adapted to communicate the calculated characteristics to the location processing device.
